(19) United States
(12) Patent Application Publication
(10) Pub. No.: US 2008/0285540 A1
(43) Pub. Date: Nov. 20, 2008

(54) USING PRESENCE PROXIES TO CONSTRAIN LOCAL PRESENCE INFORMATION TO A SUB-NETWORK WHILE USING A PRESENCE SERVER EXTERNAL TO THE SUB-NETWORK TO HANDLE OTHER PRESENCE INFORMATION

(75) Inventors: Erik J. Burckart, Raleigh, NC (US); John P. Cammarata, Wake Forest, NC (US); Madhu Chetuparambil, Raleigh, NC (US); Victor S. Moore, Lake City, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/750,566

(22) Filed: May 18, 2007

(51) Int. Cl. H04L 12/28

(52) U.S. Cl. 370/351

(57) ABSTRACT

The present invention discloses a solution that uses presence proxies to handle local presence information while using a presence server to handle extra-local presence information. In the invention, a computing system can include multiple presence user agents (PUAs), multiple watchers, multiple presence proxies, and a presence server. The PUAs can be are grouped into two or more sub-networks. The watchers can also be grouped by sub-network. The PUAs and the watchers can each be associated with a presentity. A presence proxy can be associated with each of the sub-networks. Exclusively local presence services for each sub-network ears be handled by the associated presence proxy. The presence proxy can route presence information for other presence services (those not exclusively local) to and from the presence server.

### BACKGROUND

1. Field of the Invention

The present invention relates to the field of presence information handling and, more particularly, to using presence proxies to constrain local presence information to a sub-network while using a presence server external to the sub-network to handle other presence information.

2. Description of the Related Art

A conventional presence server is a physical entity that centrally manages presence information for a set of users and devices to which other users and devices can subscribe. FIG. 1 (Prior Art) illustrates a conventional system 100 that includes a presence server 120. In system 100, a communication node 110 provides presence information to the presence server 120. The communication node 110 can include presentity 112 (e.g., a user) that utilizes a presence user agent 114 (PUA) (e.g., a computer, phone, or other communication device). The presence server 120 can function as a presence agent 122 that handles received presence information and handles subscription requests. Presence information about node 110 can be stored in data store 126 and can be automatically updated when status changes to presentity 112 and/or PDA 114 occur.

One or more clients 130 can utilize a series of watchers 132-136 to subscribe to the presence server 120. Each watcher 132-136 typically corresponds to a particular presentity, such as Presentity A, Presentity B, and Presentity C. When client 130 desires current presence information for Presentity A, a watcher 132 will be established that subscribes to presence information related to Presentity A. Each client 130 can utilize multiple watchers 132-136 to receive presence information for different presentities 112. Multiple clients 130 can concurrently establish different subscriptions for the same presentity 112. Each concurrent subscription with the presence server 120 can increase a load on the server 120. That is, programmatic actions are required by the presence server 120 for each subscription and notification event, which taken together can be CPU and network intensive. Because load on the presence server 120 increases as a number of client 130 subscriptions increase, system 100 can generally have scaling difficulties.

A significant volume of presence services utilized by an organization concern intra-organization services. For example, in a relatively large corporate office location, most presence services will concern presence information of personnel working in the office location that is provided to other personnel at the same office location. This situation is analogous to that of telephone communication systems. For example, organizations often use a private branch exchange (PBX) to handle internal calls for a set of personnel at a geographic location, which saves enough on carrier service charges to justify PBX related expenses. At present, no PBX equivalent is used for presence services.

### SUMMARY OF THE INVENTION

The preset invention discloses presence proxies that independently handle local presence services for a sub-network and that route non-local presence services to a presence server. Use of a presence proxy decreases load imposed on a presence server, which permits presence services to be scaled. More specifically, the presence proxy can intercept messages conveyed between sub-network clients and a presence server. The presence proxy can determine when presence information generated within the sub-network is required by external clients, in which case the internal presence information is forwarded to the presence server. The presence proxy can also establish subscriptions with the presence server, which permits the presence proxy to provide externally generated presence information managed by the presence server to internal clients. Internally generated presence information for internal clients only, can be handled exclusively by the presence proxy.

In one embodiment, the presence proxy can also minimize a number of presence service subscriptions handled by the presence server by grouping subscriptions for every watcher within a sub-network handled by the presence proxy into a single subscription between the presence proxy and the presence server. The presence proxy can convey notifications related to this single subscription to each subscribing watcher in the sub-network.

The present invention can be implemented in accordance with numerous aspects consistent with the material presented herein. For example, one aspect of the present invention can include a computing system including multiple presence user agents (PUAs), multiple watchers, multiple presence proxies, and a presence server. The PUAs can be grouped into two or more sub-networks. The watchers can also be grouped by sub-network. The PUAs and the watchers can each be associated with a presentity. A presence proxy can be associated with each of the sub-networks. Exclusively local presence services for each sub-network can be handled by the associated presence proxy. The presence proxy can route presence information for other presence services (those not exclusively local) to and from the presence server.

Another aspect of the present invention can include a presence proxy including a presence information handler, a locality determination engine, an intra-region handler, and an extra region handler. The presence information handler can receive presence information published from intra-region presence user agents (PUAs) and can receive subscriptions from intra-region watchers. The locality determination engine can determine whether received publications from presence user agents (PUAs) and subscriptions from watchers relate exclusively to intra-region presence services. The intra-region handler can accept, manage, and distribute presence information for infra-region presence services that relate exclusively to intra-region components as determined by the locality determination engine. The extra region handler can route presence information for presence services to and from a presence server external to a region associated with the presence proxy.

Still another aspect of the present invention can include a method for handling presence information. In the method, a presence proxy can receive presence information related to all clients in a sub-network. The presence proxy can determine whether received presence information is associated with an infra-regional service. An intra-regional service can be a presence service that relates exclusively to clients included in the sub-network. When the determining step indicates that presence information is associated with an intra-regional service, the presence proxy can handle presence service operations without reliance upon an external presence server. When dealing with extra-regional services, the presence proxy can convey presence information to the presence server, which handles presence service operations.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

It should also be noted that the methods detailed herein can also be methods performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 (Prior Art) illustrates a conventional presence system.

FIG. 2 is a schematic diagram of a system for a scalable presence system, where presence proxies handle sub-network presence information to reduce a load placed on a presence server in accordance with an embodiment of the inventive arrangements disclosed herein.

FIG. 3 is a schematic diagram of a system illustrating a use of a presence proxy for reducing load on a presence server in accordance with an embodiment of the inventive arrangements disclosed herein.

FIG. 4 is a schematic diagram of a system illustrating a presence proxy enhanced to function as a presence server for intra-region presence services in accordance with an embodiment of the inventive arrangements disclosed herein.

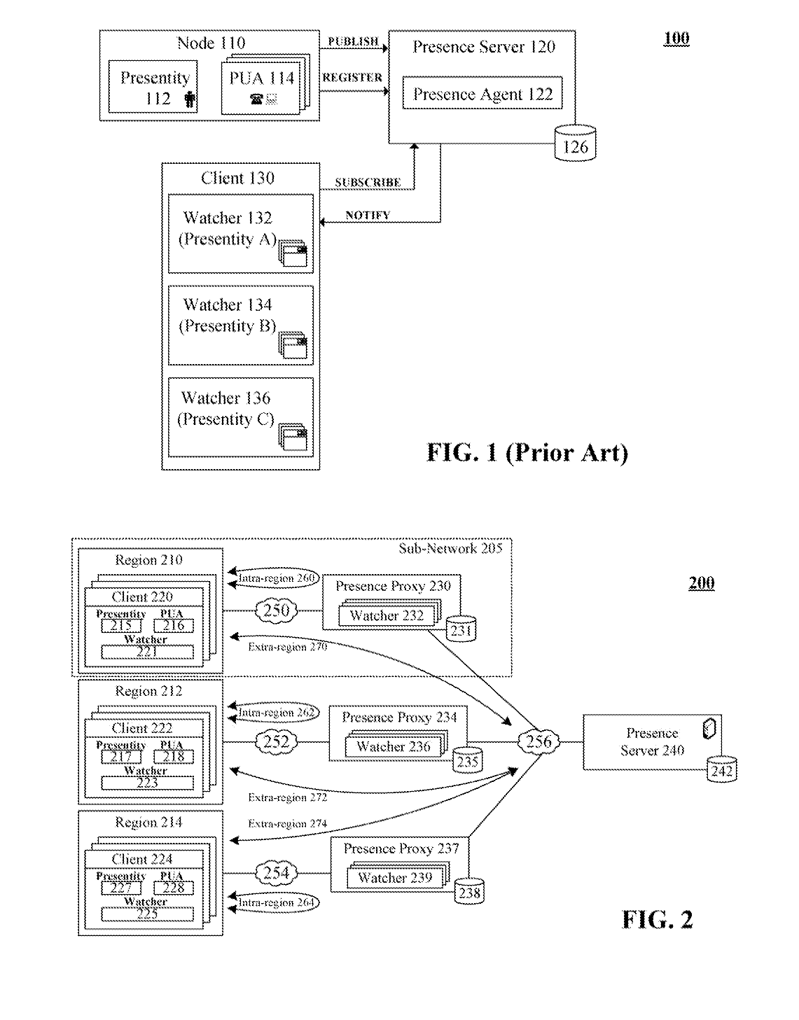

### DETAILED DESCRIPTION OF THE INVENTION

FIG. 2 is a schematic diagram of a system 200 for a scalable presence system, where presence proxies 230, 234, 237 handle sub-network 205 presence information to reduce a load placed on a presence server 240 in accordance with an embodiment of the inventive arrangements disclosed herein. Each presence proxy 230, 234, 237 can handle presence information for an associated region 210, 212, 214, which can each represent a geographic location having an associated regional network, such as sub-network 205. Each region 210, 212, 214 can include one or more clients 220, 222, 224. Each client 220 can be associated with a presentity 215, 217, 227, a presence user agent (PUA) 216, 218, 228, and/or a watcher 221, 223, 225. Each presence proxy 230, 234, 237 can function as a presence server that handles intra-region 260, 262, 264 presence services. The presence proxy 230 can route extra-region 270, 272, 274 present information to the presence server 240 for handling. In one embodiment, the presence proxy 230, 234, 237 can also multiplex many subscriptions of intra-region clients 220, 222, 224 into a single subscription, which further reduces load on the presence server 240.

As used herein, each client 220, 222, 224 can provide presence information to the presence server 240 and/or can receive presence information tram the presence server 240 related to other clients 220, 222, 224. Communication nodes (e.g., clients 220, 222, 224) that convey presence information to the server 220 can each include presentity 215, 217, 227 and one or more presence user agent (PUA) 216, 218, 228. The presentity 215, 217, 227 can provide presence information to a presence service. The presentity 215, 217, 227 can be used to model a presence being exposed and is independent of its manifestation in any user interface. In practice, the presentity 215, 217, 227 typically is used to uniquely identify a person.

Bach PUA 216, 218, 228 can be a means for a principle to manipulate zero or more presentities 212, where a principle is a human, a program, or a collection of users or programs that choose to appear to a presence service (provided by the presence server 240) as a single unique actor distinct from other principles. Typically, the PUA 216, 218, 228 can be a computer, mobile telephone, a mobile computing device, SIP phone, two-way radio, personal data assistant, a client application (e.g., an IM application, a softphone application, etc) or other computing device that is used by the presently 215, 217, 227. That is, the presentity 215, 217, 227 can use the PUA 216, 218, 228, which publishes information to the presence server 240 or proxy 230, 234, 237 and/or which registers with the presence server 240 or proxy 230, 234, 237.

The presence server 240 can collect, manage, store, and distribute presence information regarding the access, availability, and willingness to communicate with other users. The presence server 240 can enable the extension of various telecommunication service provider applications and services to include collaboration information and how best to reach people. That is, the presence server 240 provides one or more presence services.

In one embodiment, the presence server 240 can be a stand-alone, carrier-grade, IP Multimedia Subsystem (IMS) compliant server. In another embodiment, 240 a cluster of servers can be linked to create a single virtual, presence server 240. Additionally, the presence server 240 can support standard presence information data format (PIDF) and rich presence information data (RPID). Communications with the presence server 240 can be based on Session initiation Protocol (SIP) and can conform to Internet Engineering Task Force (IETF) specifications for PUBLISH, SUBSCRIBE, and NOTIFY. Numerous commercial solutions can function as presence servers 240 including, but not limited to the WEBSPHERE presence server, CISCO unified presence server, ORACLE presence server. MICROSOFT OFFICE LIVE COMMUNICATION SERVER, and the like.

The presence proxy 230, 234, 237, can intercept messages conveyed between regional clients 220, 222, 224 and the presence server 240 to reduce load on the presence server 240. The presence proxy 230, 234, 237 reduces load by performing all presence server functions for intra-region 260, 262, 264 presence information and presence services. Intra-region 260, 262, 264 presence information/services are those which do not have watchers 221, 223,225 outside an associated region 210, 212, 214 for PUBLISHED requests and that do not require NOTIFICATIONS of activities of PUBLICATIONS from PUAs 216, 218, 228 outside the associated region 210, 212, 214. The presence proxy 230, 234, 237 can also optionally group subscriptions and related notifications for all clients 220, 222, 224 in a region 210, 212, 214 handled by the proxy 230, 234, 237.

Each watcher 221, 223, 225, 232, 236, and/or 239 can request presence information about one or more presentity 215, 217, 227 or watcher 221, 223, 225, 232, 236, and/or 239. Special types of watchers 221, 223, 225, 232, 236, and/or 239 can include a fetcher, a poller, and a subscriber. It is possible for a watcher 221, 223, 225, 232, 236, and/or 239 to define which parts of presence information is received using a set of configurable rules or filters.

The presence proxies 230, 234, 237 and the presence server 240 can each access a data store 231, 235, 238, and 242, within which information can be stored. Data stores 231, 235, 238, and 242 can be a physical or virtual storage space configured to store digital information. Data stores 231, 235, 238, and 242 can be physically implemented within any type of hardware including, but not limited to, a magnetic disk, an optical disk, a semiconductor memory, a digitally encoded plastic memory, a holographic memory, or any other recording medium. Each of the data stores 231, 235, 238, and 242 cart be a stand-alone storage unit as well as a storage unit formed from a plurality of physical devices. Additionally, information can be stored within data stores 231, 235, 238, and 242 in a variety of manners. For example, information can be stored within a database structure or can be stored within one or more files of a file storage system, where each file may or may not be indexed for information searching purposes. Further, data stores 231, 235, 238, and 242 can utilize one or more encryption mechanisms to protect stored information from unauthorized access.

The clients 220, 222, 224, proxies 230, 234, 237, and presence server 240 can be communicatively linked to each other via networks 250, 252, 254, and 256. Each network 250, 252, 254, and 256 can include any hardware/software/and firmware necessary to convey data encoded within carrier waves. Data can be contained within analog or digital signals and conveyed though data or voice channels. The networks 250, 252, 254, and 256 can include local components and data pathways necessary for communications to be exchanged among computing device components and between integrated device components and peripheral devices. The networks 250, 252, 254, and 256 can also include network equipment, such as routers, data lines, hubs, and intermediary servers which together form a data network, such as the Internet. The networks 250, 252, 254, and 256 can also include circuit-based communication components and mobile communication components, such as telephony switches, modems, cellular communication towers, and the like. The networks 250, 252, 254, and 256 can include line based and/or wireless communication pathways.

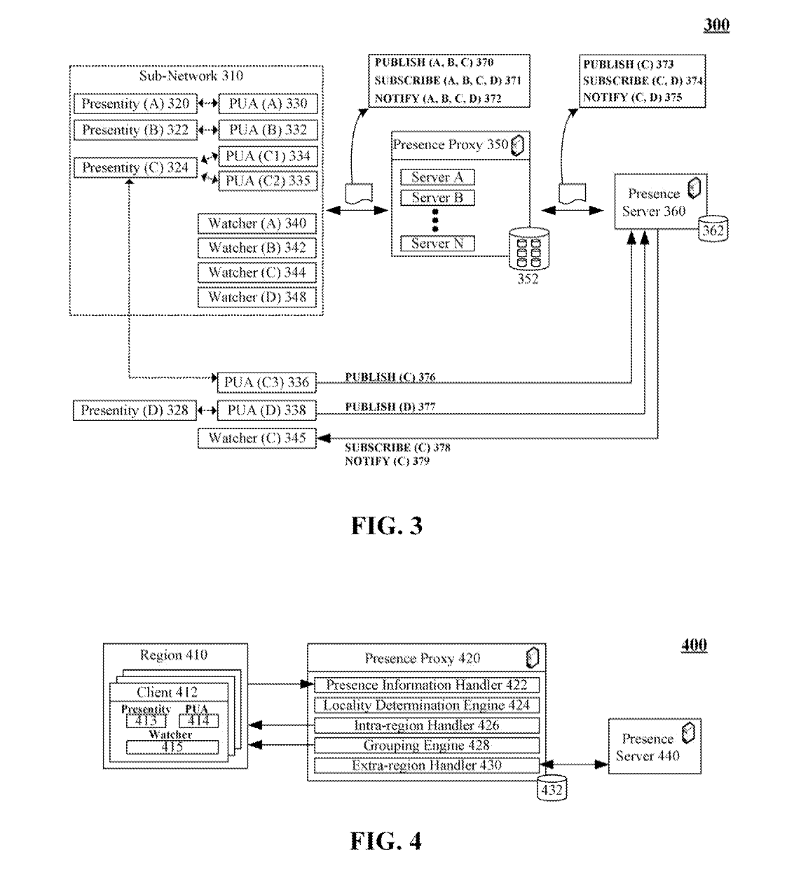

FIG. 3 is a schematic diagram of a system 300 illustrating a use of a presence proxy 350 for reducing load on a presence server 360 in accordance with an embodiment of the inventive arrangements disclosed herein. The system 300 shows a sub-network 310 that includes presentities 320-324. PUAs 330-335, and watchers 340-348 associated with presence proxy 350. The presence proxy 350 communicates with presence server 360. Presence proxy 350 can store presence information in data store 352. Presence server 360 can store presence information in data store 362. The presence server 360 can provide presence services to PUA 336-338 and watcher 345.

Presentity 320 can also be referred to as Presentity A which uses PUA 330 to communicate with proxy 350. Presentity 322, which is associated with PUA 332, can be alternatively referred to as Presentity B. Presentity 324 (alternatively referenced as Presentity C) can be associated with PUA 334, PUA 335, and PUA 336. PUA 336 can be external to the sub-network 310. Presentity 328 (alternatively referenced as Presentity D) can use PUA 338, both of which are external to sub-network 310. Watchers 340, 342, 344, and 348 subscribe to Presentity A, Presentity B, Presentity C, and Presentity D, respectively. Watcher 345 also subscribes for Presentity C presence information.

In system 300, Presentities A, B, and C all publish 370 presence information to the presence proxy 350. The presence proxy 350 can determine that one watcher (watcher 345) external to sub-network 310 subscribes 378 to Presentity C information, but that no external watchers have subscribed to information concerning Presentities A and B. Based on this determination, the presence proxy 350 can publish 373 presence information concerning Presentity C to presence server 360, which notifies 379 watcher 345 as appropriate. Presentity A and 8 information from messages 370 can be stored in data store 352 can be handled by presence proxy 350. Specifically, proxy 350 can notify 372 watchers 340-342 appropriately in accordance with subscriptions 371.

PUA 338 can publish 377 presentity information associated with Presentity D to the presence server 360, PUA 336 can publish 376 information related to Presentity C to the presence server 360. Watchers 344 and 348 subscribe 371 for Presentity C and D information via proxy 350. Proxy 350 subscribes 374 for Presentity C and D information with presence server 360. The subscriptions 374 and 371 cause server 360 to notify 375 the proxy of changes related to Presentity C and D. The proxy 350, in turn, notifies 372 watcher 344 and 348 as appropriate.

In one embodiment, functions of the presence proxy 350 can be distributed across different servers (A, B, . . . N) to add fault tolerance and/or load balancing capabilities to system 300. Similarly, proxy data store 352 and/or presence server data store 362 can be implemented in a fault tolerant, redundant, and/or distributed manner. For example, the data store 352 can be implemented as a Redundant Array of independent Disks (RAID) configuration. The data store 352 can also be implemented as a set of distributed mirrored storage spaces.

FIG. 4 is a schematic diagram of a system 400 illustrating a presence proxy 420 enhanced to function as a presence server for intra-region presence services in accordance with an embodiment of the inventive arrangements disclosed herein. The presence proxy 420 can function as a communication intermediary between clients 412 of region 410 and a presence server 440. Each client 412 can include a PUA 414 used by a presentity 413 and/or a watcher 415 that subscribes to a presence service associated with a presentity. Intra-region presence services involving only intra-region clients 412 can be handled exclusively by proxy 420, where other presence services can involve the presence server 440.

The presence proxy 420 can include a presence information handler 422, a locality determination engine 424, an intra-region handler 426, a grouping engine 428, an extra-region handler 430, and/or a proxy data store 432. The presence information handler 422 can receive presence information published from intra-region presence user agents (PUAs) 414 and can receive subscriptions from intra-region watchers 415. The intra-region handler 426 can accept, manage, and distribute presence information for intra-region presence services that relate exclusively to intra-region clients 412 as determined by the locality determination engine 424. The extra-region handler 430 can route presence information for presence services to and from a presence server 440. Using handler 430, the presence proxy 420 can function as a client that subscribes to the presence server 440 and can function as a node that publishes information from clients 412 to server 440.

The locality determination engine 424 can determine whether received publications from presence user agents (PUAs) 414 and subscriptions from watchers 415 relate exclusively to intra-region presence services. In one embodiment, engine 424 can cause the proxy 420 to subscribe to a service relating to a presentity with the server 440 each time a client 412 subscribes for the presentity. Therefore, when the subscription with the server 440 results in one or more notification being delivered from an extra-region PUA, the determination engine 424 can automatically ascertain that all presence services related to the presentity are extra-regional in nature, meaning they are not exclusively local to region 410. The locality determination engine 424 also can query the server 440 for any external watchers subscribing to presentities 413 using PUAs 414 of region 410, which indicates that presence services relating to that presentity are extra-regional. Changes in presence services involving presence server 440 can be dynamically detected by the engine 424, which can cause updates regarding which presence services are intra-regional and which are extra-regional.

In one embodiment, the grouping engine 428 can group watcher subscriptions related to presence services involving server 440. Because of the grouping engine 428, foe presence server 440 need only handle a single subscription for a particular presentity for region 410 regardless of how many clients 412 in the region 410 have subscribed to the presentity. In other words, the grouping engine 428 essentially multiplexes many subscriptions involving server 440 into a single subscription on a regional basis.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A computing system comprising:
a plurality of presence user agents (PDAs) at least a portion of which are grouped into a plurality of sub-networks within which they reside, wherein each presence user agent (PUA) is associated with a presentity;
a plurality of watchers at least a portion of which are grouped into the plurality of sub-networks within which they reside, wherein each watcher subscribes for presence services associated with a presentity, which is associated with one of the presence user agents;
a plurality of presence proxies, each of which is associated with one of the sub-networks, wherein exclusively local presence services for the associated sub-network are handled by the presence proxy, and wherein the presence proxy routes presence information for presence services that are not exclusively local to the associated sub-network to a presence server; and
the presence server which handles presence services that are not exclusively local to the associated sub-network.

2. The system of claim 1, wherein each of the presence proxies are further configured to group watcher subscriptions to presence services that are not exclusively local to the associated sub-network into a single subscription between the presence proxy and the presence server for all watchers in the associated sub-network.

3. The system of claim 1, wherein at least one of the presence proxies distributes a cache in which presence information for the presence proxy is maintained in a redundant fashion to ensure failure tolerance capabilities exist for the cache.

4. The system of claim 1, wherein at least one of the presence proxies is functionally implemented across a plurality of physical servers residing in the sub-network associated with the presence proxy.

5. The system of claim 1, wherein communications among the presence server, each of the presence proxies, each of the watchers, and each of the presence user agents (PUAs) use Session Initiation Protocol (SIP) based messages in conformance with an open communication standard.

6. The system of claim 5, wherein the open standard is an Internet Engineering Task Force (IETF) based standard, and wherein the presence server and the presence proxies support PUBLISH, SUBSCRIBE, and NOTIFY operations.

7. The system of claim 1, wherein the presence server and the presence proxies support standard presence information data format (PIDF) and rich presence information data (RPID).

8. The system of claim 1, wherein each of the sub-networks is associated with a geographic region.

9. A presence proxy comprising:
a presence information handler configured to receive presence information published from a plurality of intra-region presence user agents (PUAs) and configured to receive subscriptions from a plurality of intra-region watchers;
a locality determination engine configured to determine whether received publications from presence user agents (PUAs) and subscriptions from watchers relate exclusively to intra-region presence services;
an ultra-region handler configured to accept manage, and distribute presence information for intra-region presence services that relate exclusively to intra-region components as determined by the locality determination engine; and
an extra region handler configured to route presence information for presence services to and from a presence server external to a region associated with the presence proxy as determined by the locality determination engine.

10. The presence proxy of claim 9, further comprising:
a subscription/notification grouping engine configured to group watcher subscriptions to presence services that are not exclusively local to the associated sub-network into a single subscription between the presence proxy and the presence server for all watchers in the associated sub-network.

11. The presence proxy of claim 9, wherein for each subscription received by the presence information handler relating to a presentity, the presence proxy subscribes with the presence server for an equivalent presentity.

12. The presence proxy of claim 11, wherein when a watcher external to the region also subscribes with the presence server for the presentity, the locality determination engine determines presence services related to the presentity do not relate exclusively to intra-region presence services.

13. The presence proxy of claim 11, wherein when a presence user agent external to the region publishes information associated with the presentity, the locality determination engine determines presence services related to the presentity do not relate exclusively to intra-region presence services.

14. The presence proxy of claim 11, wherein communications among the presence server, the presence proxy, each of the watchers, and each of the presence user agents (PUAs) use Session Initiation Protocol (SIP) based messages in conformance with an open communication standard.

15. The presence proxy of claim 14, wherein the open standard is an Internet Engineering Task force (IETF) based standard, and wherein the presence server and the presence proxies support PUBLISH, SUBSCRIBE, and NOTIFY operations.

16. A method for handling presence information comprising:
a presence proxy receiving presence information related to all clients in a sub-network;
the presence proxy determining whether received presence information is associated with an intra-regional service, wherein an intra-regional service is a presence service that relates exclusively to clients included in the sub-network;
when the determining step indicates that presence information is associated with an intra-regional service, the presence proxy handling presence service operations relating to the received presence information without reliance upon a presence server external to the sub-network; and
when the determining step indicates that presence information is not associated with an intra-regional service, the presence proxy conveying the received presence information to the presence server that handles presence service operations relating to the received presence information.

17. The method of claim 16, wherein the presence proxy is configured to group a plurality of watcher subscriptions to presence services that are not exclusively local to the sub-network into a single subscription between the presence proxy and the presence server.

18. The method of claim 16, wherein the presence server and the presence proxy are configured to accept manage, and distribute presence information using Session Initiation Protocol (SIP) based messages and in conformance with an Internet Engineering Task force (IETF) based standard, and wherein the presence server provides operations for PUBLISH, SUBSCRIBE, and NOTIFY.

19. The method of claim 18, wherein messages conveyed between the clients and the presence proxy and between the presence proxy and the presence server conform to a standardized presence information format, wherein the standardized presence information format is at least one of a presence information data format (PIDF) and rich presence information data (RPID) format.

20. The method of claim 16, wherein said steps of claim 16 are steps performed automatically by at least one machine in accordance with at least one computer program having a plurality of code sections that are executable by the at least one machine, said at least one computer program being stored in a machine readable memory.
